(19) United States
(12) Patent Application Publication
(10) Pub. No.: US 2026/0079788 A1
(43) Pub. Date: Mar. 19, 2026

(54) CONTROL DEVICE, STORAGE SYSTEM, CONTROL METHOD, AND PROGRAM

(71) Applicants: Kabushiki Kaisha Toshiba, Tokyo (JP); Toshiba Electronic Devices & Storage Corporation, Tokyo (JP)

(72) Inventors: Ling LIN, Kawasaki Kanagawa (JP); Kazuo CHOKKI, Fujisawa Kanagawa (JP)

(21) Appl. No.: 19/064,060

(22) Filed: Feb. 26, 2025

(30) Foreign Application Priority Data
Sep. 18, 2024 (JP) 2024-160787

(51) Int. Cl. G06F 11/10

(52) U.S. Cl. CPC G06F 11/1016; G06F 11/1048; G06F 11/1064

(57) ABSTRACT

A control device is configured to control a volatile memory. The control device is configured such that when an error has occurred in reading data stored in a storage area of the volatile memory and an error occurrence situation in the storage area in which the error has occurred satisfies a predetermined first occurrence condition, the control device sets the storage area in which the error has occurred as a read cache area which is used to store read data read from a predetermined storage medium.

### CROSS-REFERENCE TO RELATED APPLICATION

This application is based upon and claims the benefit of priority from Japanese Patent Application No. 2024-160787, filed on Sep. 18, 2024; the entire contents of which are incorporated herein by reference.

### FIELD

Embodiments described herein relate generally to a control device, a storage system, a control method, and a program.

### BACKGROUND

In a storage system including a volatile memory in the related art, when an error occurs in reading data stored in the volatile memory, measures for not using a storage area in which the error has occurred have been taken regardless of whether the error is a temporary error or a permanent error. Accordingly, there is a problem in that the number of unavailable storage areas increases in the volatile memory.

### BRIEF DESCRIPTION OF THE DRAWINGS

FIG. 1 is a block diagram illustrating a configuration of a storage system according to a first embodiment.

FIG. 2 is a diagram schematically illustrating an area in which data is stored in a first volatile memory.

FIG. 3 is a flowchart illustrating part of a process flow that is performed by a control device according to the first embodiment.

FIG. 4 is a flowchart illustrating a process flow that is performed when it is determined whether a first occurrence condition has been satisfied according to the first embodiment.

FIG. 5 is a diagram schematically illustrating an area in which data is stored in the first volatile memory in a state in which one storage area is a read cache area according to the first embodiment.

FIG. 6 is a flowchart illustrating a process flow that is performed when data stored in a storage area which is a read cache area is accessed according to the first embodiment.

FIG. 7 is a flowchart illustrating a process flow that is performed when it is determined whether a second occurrence condition has been satisfied according to the first embodiment.

FIG. 8 is a diagram schematically illustrating a storage area in the first volatile memory in a state in which a storage area which is a read cache area is set as an unavailable storage area and a replacement process has been performed according to the first embodiment.

FIG. 9 is a block diagram illustrating a storage system according to a second embodiment.

### DETAILED DESCRIPTION

A control device according to embodiments is a control device that is configured to control a volatile memory. The control device is configured such that when an error has occurred in reading data stored in a storage area of the volatile memory and an error occurrence situation in the storage area in which the error has occurred satisfies a predetermined first occurrence condition, the control device according to the embodiment sets the storage area in which the error has occurred as a read cache area which is used to store read data read from a predetermined storage medium.

Hereinafter, a control device, a storage system, a control method, and a program according to embodiments will be described with reference to the drawings.

### First Embodiment

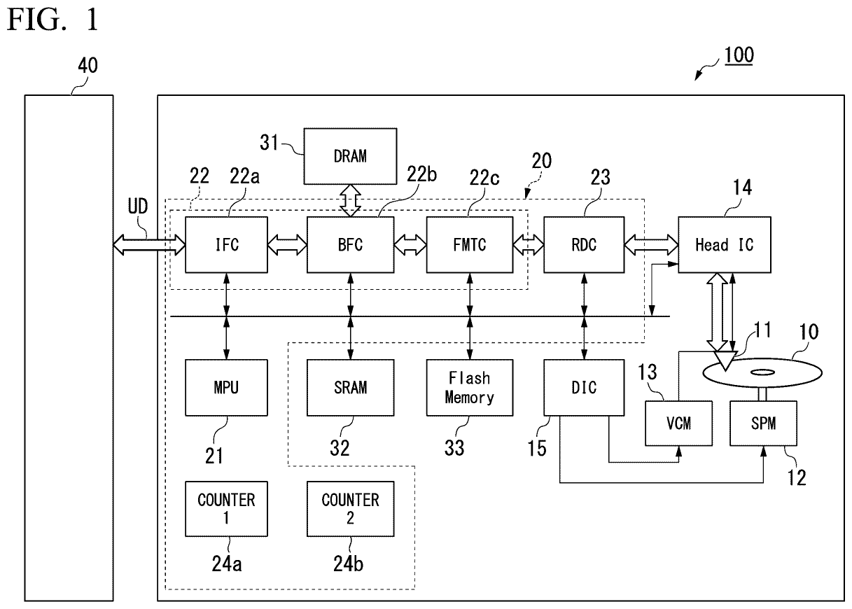

FIG. 1 is a block diagram illustrating a configuration of a storage system 100 according to a first embodiment. The storage system 100 illustrated in FIG. 1 is a disk device including a disk 10 as a storage medium. More specifically, the storage system 100 is a magnetic disk device into which a hard disk drive is built. The storage system 100 can store information as digital data. The storage system 100 is driven on the basis of commands from a host device 40. The host device 40 is, for example, a personal computer. The host device 40 is not particularly limited as long as it is a device that gives a command to the storage system 100. The host device 40 can write information on the storage system 100 and read data stored in the storage system 100.

As illustrated in FIG. 1, the storage system 100 includes a disk 10, a head 11, a spindle motor 12, a voice coil motor 13, a head amplifier IC 14, a driver IC 15, a control device 20, a first volatile memory 31, a second volatile memory 32, and a nonvolatile memory 33. The disk 10 in the first embodiment is a magnetic disk. The disk 10 in the first embodiment corresponds to a predetermined storage medium. The disk 10 is rotated by the spindle motor 12. For example, a plurality of disks 10 are provided in the storage system 100.

The head 11 is a magnetic head that enables reading data stored in the disk 10 and writing data to the disk 10. Although not illustrated, the head 11 includes a read head for reading data stored in the disk 10 and a write head for writing data to the disk 10. The head 11 is provided for each disk 10. The head 11 is moved to a position facing a recording surface of the disk 10 and a position not facing the recording surface of the disk 10 by the voice coil motor 13. The head 11 can perform reading data from the recording surface of the disk 10 and writing data to the recording surface of the disk 10 at the position facing the recording surface of the disk 10.

Although not illustrated, the head amplifier IC 14 includes a read amplifier and a write driver. The read amplifier amplifies a signal of data read from the disk 10 by the head 11 and outputs the amplified signal to a read/write channel 23 which will be described later in the control device 20. The write driver outputs a write current corresponding to data output from the read/write channel 23 to the head 11. The head 11 writes data to the disk 10 on the basis of the write current output from the write driver.

The driver IC 15 is configured to control driving of the spindle motor 12 and driving of the voice coil motor 13 on the basis of a command from the control device 20.

The control device 20 is a system controller that is configured to control the storage system 100. The control device 20 is, for example, a large scale integration (LSI) circuit referred to as a system-on-a-chip (SoC) in which a plurality of elements are integrated on a single chip. The control device 20 is electrically connected to the head amplifier IC 14, the driver IC 15, the first volatile memory 31, the second volatile memory 32, and the nonvolatile memory 33. The control device 20 includes a microprocessor 21, a hard disk controller 22, and a read/write channel 23.

The hard disk controller 22 is configured to control data transmission between the host device 40 and the read/write channel 23 on the basis of a command from the microprocessor 21. The hard disk controller 22 is electrically connected to the microprocessor 21, the read/write channel 23, the head amplifier IC 14, the driver IC 15, the first volatile memory 31, the second volatile memory 32, and the nonvolatile memory 33. The hard disk controller 22 includes an interface controller 22a, a buffer controller 22b, and a format controller 22c. The interface controller 22a is configured to control an interface with the host device 40. The interface controller 22a is configured to read a command input from the host device 40 and perform reception and transmission of data. The buffer controller 22b is configured to temporarily record data input from the host device 40 via the interface controller 22a and data read from the disk 10 on the first volatile memory 31. The format controller 22c is configured to convert formats of data input from the buffer controller 22b and data input from the read/write channel 23.

The read/write channel 23 is configured to perform signal processing of data sent from the disk 10 to the host device 40 and data sent from the host device 40 to the disk 10 on the basis of a command from the microprocessor 21. The read/write channel 23 has, for example, a function of measuring signal quality of data.

The first volatile memory 31 and the second volatile memory 32 are semiconductor memories in which data stored therein disappears when supply of electric power thereto is cut off. In the first embodiment, data is temporarily recorded on the first volatile memory 31 by the buffer controller 22b. In the first embodiment, the first volatile memory 31 is a dynamic random access memory (DRAM). In the first embodiment, the first volatile memory 31 is used as a cache for read data which is read from the disk 10 which is a storage medium and write data which is written to the disk 10. In the second volatile memory 32, data necessary for processes in the constituent circuits of the storage system 100 or the like is recorded. In the first embodiment, the second volatile memory 32 is a static random access memory (SRAM). The first volatile memory 31 and the second volatile memory 32 may be provided integrally as a single volatile memory. The first volatile memory 31 may be an SRAM, a synchronous dynamic random access memory (SDRAM), a ferroelectric random access memory (FeRAM), a magnetoresistive random access memory (MRAM), or the like. The second volatile memory 32 may be a DRAM, an SDRAM, a FeRAM, an MRAM, or the like.

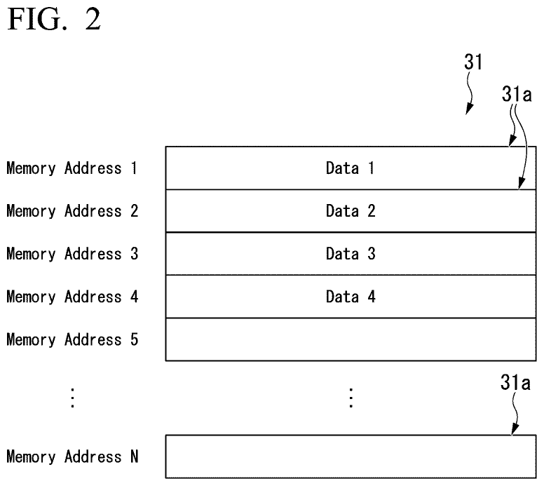

FIG. 2 is a diagram schematically illustrating an area in which data is stored in the first volatile memory 31. As illustrated in FIG. 2, the first volatile memory 31 includes a plurality of storage areas 31a. Each of the plurality of storage areas 31a can store data. A memory address is assigned to each storage area 31a. In FIG. 2, an example in which data is stored in the storage areas 31a with memory addresses 1 to 4 is illustrated.

Data stored in each storage area 31a is one among read data, write data, and fixed data. The read data is data which is read from the disk 10 which is a storage medium. The write data is data which is written to the disk 10 which is a storage medium. The read data and the write data are cache data which is temporarily stored in the storage areas 31a of the first volatile memory 31. The fixed data is data which is not replaced after the storage system 100 is powered on until the storage system 100 is powered off. The fixed data is, for example, system data which is used to drive the storage system 100. In the first embodiment, the fixed data is data other than the read data and is data stored in the disk 10 which is a storage medium.

The nonvolatile memory 33 is a semiconductor memory that continues to store data recorded thereon even when supply of electric power thereto is cut off. In the first embodiment, the nonvolatile memory 33 is a flash memory. The nonvolatile memory 33 is, for example, a NOR-type or NAND-type flash memory. In the nonvolatile memory 33, at least part of a program for driving the storage system 100, data necessary before data is read and written with respect to the disk 10, and the like are recorded.

Outlined arrows in FIG. 1 indicate a flow of user data UD. User data UD input from the host device 40 to the storage system 100 is input to the buffer controller 22b via the interface controller 22a and is temporarily recorded on the first volatile memory 31 by the buffer controller 22b. The user data UD recorded on the first volatile memory 31 is read by the buffer controller 22b and is converted to a format which can be recorded on the disk 10 by the format controller 22c. The post-conversion user data UD is sent to the head amplifier IC 14 via the read/write channel 23 and is written to the disk 10 by the head 11. When the user data UD recorded on the disk 10 is read by the host device 40, for example, the user data UD is read in the reverse order of the order in which the user data UD is written to the disk 10.

The microprocessor 21 is a controller that is configured to control the constituent circuits of the storage system 100 and is a main controller. The microprocessor 21 is configured to control the voice coil motor 13 via the driver IC 15 and perform servo control for positioning the head 11. The microprocessor 21 is configured to control the spindle motor 12 via the driver IC 15 such that the disk 10 rotates. The microprocessor 21 is configured to control an operation (a write operation) of writing data to the disk 10. The microprocessor 21 is configured to select a storage destination of data which is written to the disk 10. The microprocessor 21 is configured to control an operation (a read operation) of reading data recorded on the disk 10. The microprocessor 21 is configured to control processing of data read from the disk 10. The microprocessor 21 is electrically connected to the constituent circuits of the storage system 100.

The control device 20 includes a first counter 24a and a second counter 24b. The first counter 24a and the second counter 24b are counters for counting an error occurring at the time of access to the first volatile memory 31. The error is, for example, an error in which at least part of data stored in the first volatile memory 31 cannot be read normally. The error is either an error which occurs temporarily or an error which occurs permanently. The error which occurs temporarily is a soft error which occurs temporarily at the time of read of data stored in the first volatile memory 31 due to noise or the like. The error which occurs permanently is a hard error (a permanent defect) which occurs because there is a physical problem in the storage area 31a of the first volatile memory 31.

The first counter 24a and the second counter 24b are configured to count an error occurring in each storage area 31a of the first volatile memory 31. The first counter 24a is a counter that is configured to count an error which can be corrected by an error correction function (ECC: Error Correction Code). The second counter 24b is a counter that is configured to count an error which cannot be corrected by the error correction function. A count number of the first counter 24a is incremented when the control device 20 detects that an error which can be corrected by the error correction function has occurred. A count number of the second counter 24b is incremented when the control device 20 detects that an error which cannot be corrected by the error correction function has occurred. An initial value of the count number of the first counter 24a and an initial value of the count number of the second counter 24b are, for example, 0.

The error correction function is a function provided in the storage system 100. The error correction function is a function of correcting a part with a defect or a mistake when the soft error or the hard error occurs at the time of reading of data from the first volatile memory 31, a defect or a mistake occurs in data to be read, and a capacity of a part with the defect or the mistake is equal to or less than a predetermined capacity. The error correction function cannot correct the part with the defect or the mistake when the capacity of the defect or the mistake of data occurring due to the soft error or the hard error is larger than the predetermined capacity. A capacity of data which can be corrected by the error correction function is not particularly limited. The error correction function may be provided in any constituent of the storage system 100. The error correction function may be, for example, a function provided in the first volatile memory 31 or a function provided in the control device 20.

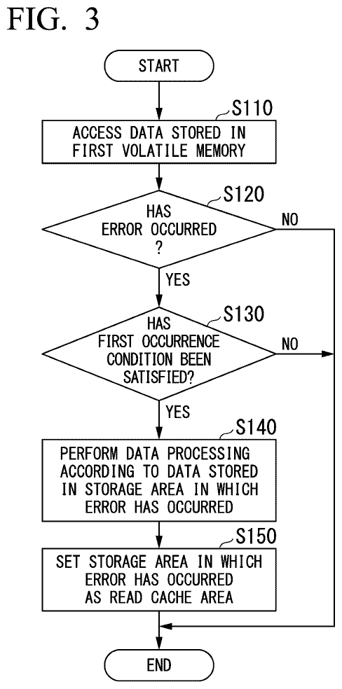

FIG. 3 is a flowchart illustrating part of a process flow that is performed by the control device 20 according to the first embodiment. In the first embodiment, the control device 20 performs the process flow illustrated in FIG. 3 using the microprocessor 21. As illustrated in FIG. 3, the control device 20 accesses data stored in the first volatile memory 31 when a command for accessing data stored in the first volatile memory 31 is issued (Step S110). The command for accessing data stored in the first volatile memory 31 is input, for example, from the host device 40 to the control device 20. When data stored in the first volatile memory 31 is accessed, the control device 20 determines whether an error has occurred (Step S120).

When no error has occurred in reading data stored in the first volatile memory 31 (Step S120: NO), the control device 20 ends the process of accessing the first volatile memory 31. When an error has occurred in reading data stored in the first volatile memory 31 (Step S120: YES), the control device 20 determines whether an error occurrence situation has satisfied a predetermined first occurrence condition (Step S130).

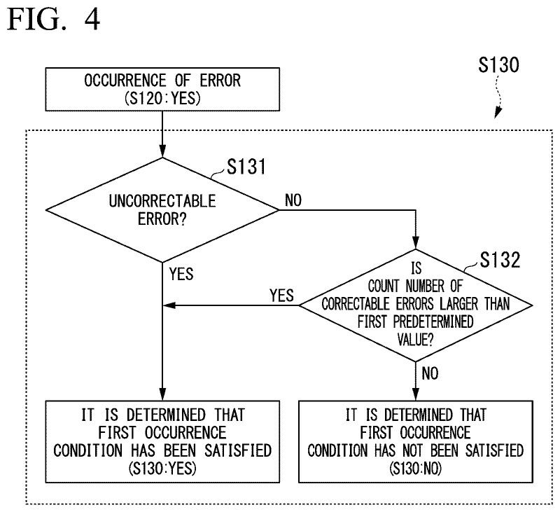

FIG. 4 is a flowchart illustrating a process flow that is performed when it is determined whether the first occurrence condition has been satisfied. As illustrated in FIG. 4, when an error has occurred (Step S120: YES), the control device 20 determines whether the occurred error is an error which cannot be corrected by the error correction function (Step S131). When a capacity of a part with the defect or the mistake in the read data is larger than the predetermined capacity, the control device 20 determines that the occurred error is an error which cannot be corrected by the error correction function. When the capacity of the part with the defect or the mistake in the read data is equal to or smaller than the predetermined capacity, the control device 20 determines that the occurred error is an error which can be corrected by the error correction function. When the occurred error is an uncorrectable error (Step S131: YES), the control device 20 determines that the first occurrence condition has been satisfied (Step S130: YES). In the first embodiment, the condition in which an error which cannot be corrected by the error correction function has occurred is a predetermined second determination condition. That is, when the second determination condition has been satisfied, the control device 20 determines that the error occurrence situation satisfies the first occurrence condition.

An error which cannot be corrected by the error correction function may be a soft error which occurs temporarily or a hard error (a permanent defect) which occurs permanently. Accordingly, when an error which cannot be corrected by the error correction function has occurred, the control device 20 cannot determine whether the error is a soft error or a hard error.

When the occurred error is a correctable error (Step S131: NO), the control device 20 determines whether a count number of the error which can be corrected by the error correction function in the storage area 31a in which the error has occurred is larger than a first predetermined value (Step S132). In Step S132 of the first embodiment, the control device 20 determines whether the count number of the first counter 24a in the storage area 31a in which the error has occurred is larger than the first predetermined value.

When it is determined in Step S132 that the count number of the first counter 24a is equal to or smaller than the first predetermined value, the control device 20 determines that the first occurrence condition has not been satisfied (Step S130: NO). When it is determined in Step S132 that the count number of the first counter 24a is larger than the first predetermined value, the control device 20 determines that the first occurrence condition has been satisfied (Step S130: YES). In the first embodiment, the condition in which the count number of an error which can be corrected by the error correction function is larger than the first predetermined value is a predetermined first determination condition. That is, when the first determination condition has been satisfied, the control device 20 determines that the error occurrence situation satisfies the first occurrence condition. The first occurrence condition in the first embodiment is a condition in which one of the first determination condition and the second determination condition has been satisfied.

The first predetermined value is, for example, an integer greater than or equal to 1. The first predetermined value may be 0. In this case, when a correctable error occurs even once, the count number of the first counter 24a is 1 which is larger than the first predetermined value. Accordingly, when a correctable error occurs, the first determination condition is satisfied, and the first occurrence condition is satisfied.

In each of the plurality of storage areas 31a, the count number of the first counter 24a may be reset when no error has occurred at the time of access to data stored in the storage area 31a. In this case, when an error has occurred continuously the larger number of times than the first predetermined value at the time of access to data in the storage area 31a, the control device 20 determines that the first determination condition has been satisfied in Step S132.

In each of the plurality of storage areas 31a, the count number of the first counter 24a may be reset whenever access to data stored in the storage area 31a is performed a predetermined number of times. In this case, when an error has occurred the larger number of times than the first predetermined value while accessing data in the storage area 31a a predetermined number of times, the control device 20 determines that the first determination condition has been satisfied in Step S132.

As illustrated in FIG. 3, when it is determined that the error occurrence situation does not satisfy the first occurrence condition (Step S130: NO), the control device 20 ends the process of accessing the first volatile memory 31. When the error occurrence situation satisfies the first occurrence condition (Step S130: YES), the control device 20 performs data processing on the basis of stored data in the storage area 31a in which an error has occurred (Step S140).

In Step S140, the control device 20 writes data in the storage area 31a in which an error has occurred in another storage area 31a when the stored data in the storage area 31a in which an error has occurred is fixed data. That is, when the stored data stored in the storage area 31a in which the first occurrence condition has been satisfied is data other than the read data read from the disk 10 which is a storage medium and is data stored in the disk 10, the control device 20 writes the stored data in another storage area 31a of the first volatile memory 31. In Step S140, the control device 20 writes read data stored in the storage area 31a in which an error has occurred in another storage area 31a when the stored data stored in the storage area 31a in which an error has occurred is the read data and the first occurrence condition has been satisfied due to the satisfaction of the second determination condition. When the first occurrence condition has been satisfied due to the satisfaction of the second determination condition and the stored data is read data, the control device 20 may write the read data again in the storage area 31a in which an error has occurred.

In Step S140, when it is determined that the first occurrence condition has been satisfied due to the satisfaction of the first determination condition and the stored data stored in the storage area 31a is fixed data, the control device 20 copies the stored data in the storage area 31a, writes the copied data to another storage area 31a, and deletes the stored data in the storage area 31a in which an error has occurred. That is, in Step S140, when it is determined that the first occurrence condition has been satisfied because the count number of an error which can be corrected by the error correction function is larger than the first predetermined value, the control device 20 copies the fixed data stored in the storage area 31a and writes the copied fixed data in another storage area 31a.

In Step S140, when it is determined that the first occurrence condition has been satisfied due to the satisfaction of the second determination condition and the stored data stored in the storage area 31a is fixed data, the control device 20 copies the fixed data stored in the disk 10, writes the copied fixed data to another storage area 31a again in the same way as when fixed data stored in the storage area 31a in which an error has occurred is written, and deletes the fixed data stored in the storage area 31a in which an error has occurred. That is, in Step S140, when it is determined that the first occurrence condition has been satisfied because an error which cannot be corrected by the error correction function has occurred, the control device 20 writes the fixed data to another storage area 31a again in the same way as when fixed data stored in the storage area 31a in which an error has occurred is written.

In Step S140, when the stored data stored in the storage area 31a in which the first occurrence condition has been satisfied is write data, the control device 20 performs data processing according to whether the first occurrence condition has been satisfied due to the satisfaction of the first determination condition or the first occurrence condition has been satisfied due to the satisfaction of the second determination condition. In Step S140, when it is determined that the first occurrence condition has been satisfied due to the satisfaction of the first determination condition and the stored data stored in the storage area 31a is write data, the control device 20 writes the write data to the disk 10 and deletes the write data stored in the storage area 31a. In Step S140, when it is determined that the first occurrence condition has been satisfied due to the satisfaction of the second determination condition and the stored data stored in the storage area 31a is write data, the control device 20 determines that a writing error has occurred and sends a signal indicating that the writing error has occurred to the host device 40.

When the data which is written to another storage area 31a in Step S140 is read data, the control device 20 sets the other storage area 31a to a data rewritable state. When the data which is written to another storage area 31a in Step S140 is fixed data, the control device 20 locks the other storage area 31a and sets the other storage area 31a to a data non-rewritable state. In Step S140, when it is determined that the first occurrence condition has been satisfied due to the satisfaction of the first determination condition and the stored data stored in the storage area 31a is write data, the control device 20 may write the write data to another storage area 31a. In this case, the control device 20 sets the other storage area 31a to which the write data has been written to a data rewritable state.

In Step S140, when the stored data stored in the storage area 31a in which an error has occurred is read data and the first occurrence condition has been satisfied due to the satisfaction of the first determination condition, the control device 20 maintains the state in which the stored read data is stored in the storage area 31a in which an error has occurred and does not write the read data to another storage area 31a. When the first occurrence condition has been satisfied due to the satisfaction of the first determination condition and the stored data is read data, the control device 20 may write the read data to another storage area 31a.

After Step 140 has been performed, the control device 20 sets the storage area 31a in which an error has occurred as a read cache area which is used to store read data read from the disk 10 (Step S150). That is, when an error has occurred in reading data stored in a storage area 31a of the first volatile memory 31 and the error occurrence situation satisfies the predetermined first occurrence condition, the control device 20 sets the storage area 31a in which an error has occurred as a read cache area which is used to store read data read from the disk 10 which is a predetermined storage medium. The read cache area is an area in which only read data is stored. In a storage area 31a which is the read cache area, data other than the read data is not stored. The control device 20 stores the memory address of the storage area 31a set as the read cache area in the nonvolatile memory 33.

After setting the storage area 31a in which the first occurrence condition has been satisfied to a read cache area, the control device 20 ends the process of accessing the first volatile memory 31. When a storage area 31a is a read cache area due to the satisfaction of the second determination condition, an uncorrectable error occurs in reading data from the storage area 31a. Accordingly, the control device 20 does not read data correctly according to access to the storage area 31a. In this case, when data stored in the storage area 31a is read data or fixed data, the data is stored in the disk 10, and thus the control device 20 can correctly read data to be read from the storage area 31a by reading the data from the disk 10. On the other hand, when data stored in the storage area 31a is write data, for example, the control device 20 sends an error indicating that data cannot be read to the host device 40 and causes the host device 40 to issue a command for writing data again.

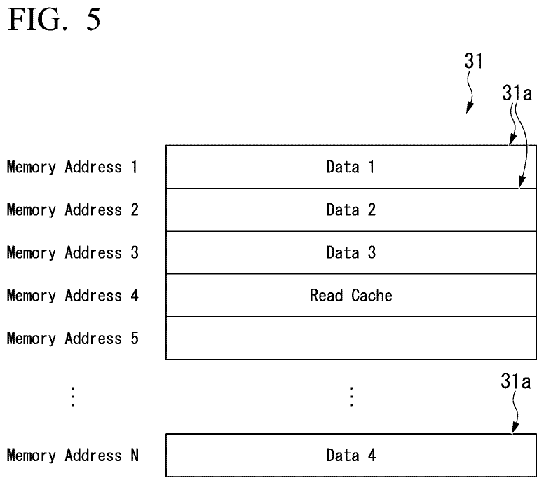

FIG. 5 is a diagram schematically illustrating areas in which data is store in the first volatile memory 31 in which one storage area 31a is a read cache area. In FIG. 5, an example in which a storage area 31a with memory address 4 is a read cache area is illustrated. In the example illustrated in FIG. 5, a state in which data 4 which is originally stored in the storage area 31a with memory address 4 is written to a storage area 31a with memory address N in Step S140 is illustrated.

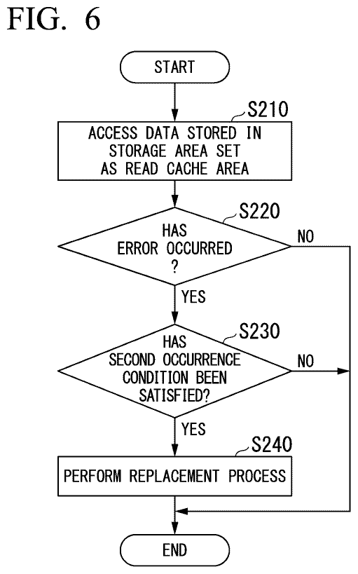

FIG. 6 is a flowchart illustrating a process flow that is performed when data stored in a storage area 31a which is a read cache area is accessed. As illustrated in FIG. 6, when a command for accessing data stored in the storage area 31a which is set as a read cache area in Step S150 out of a plurality of storage areas 31a of the first volatile memory 31 is issued, the control device 20 accesses the data stored in the storage area 31a (Step S210).

When the data stored in the storage area 31a which is the read cache area is accessed, the control device 20 determines whether an error has occurred (Step S220). When an error has not occurred in reading the data stored in the storage area 31a which is the read cache area (Step S220: NO), the control device 20 ends the process of accessing the first volatile memory 31. When an error has occurred in reading the data stored in the storage area 31a which is the read cache area (Step S220: YES), the control device 20 determines whether the error occurrence situation satisfies a predetermined second occurrence condition (Step S230).

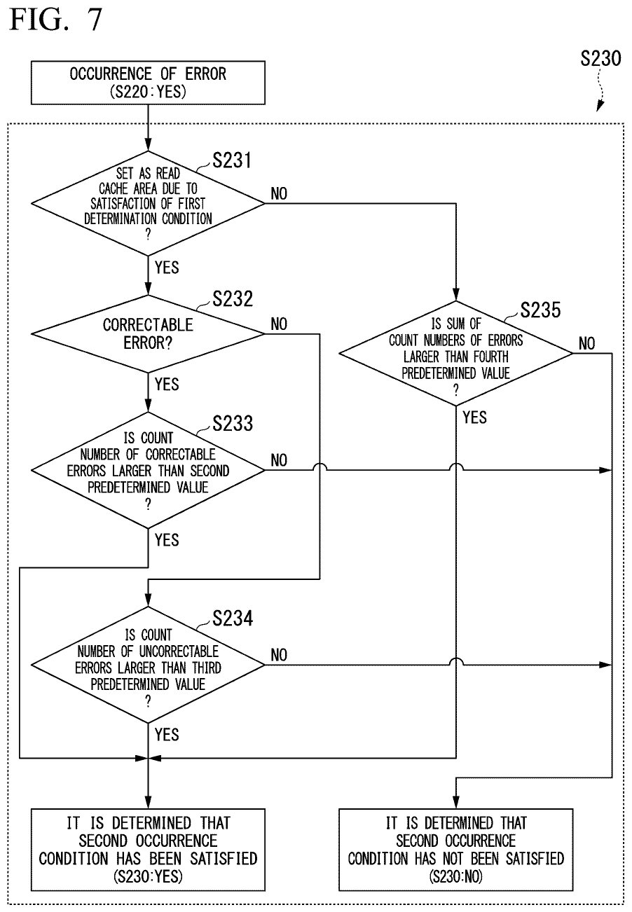

FIG. 7 is a flowchart illustrating a process flow that is performed when it is determined whether the second occurrence condition has been satisfied. As illustrated in FIG. 7, when it is determined in Step S220 that an error has occurred (Step S220: YES), the control device 20 determines whether the accessed storage area 31a is set as the read cache area due to the satisfaction of the first determination condition (Step S231). When it is determined in Step S231 that the storage area 31a is set as the read cache area due to the satisfaction of the first determination condition (Step S231: YES), the control device 20 determines whether the occurred error is an error which can be corrected by the error correction function (Step S232). When it is determined in Step S232 that the error is an error which can be corrected by the error correction function (Step S232: YES), the control device 20 determines whether the count number of the correctable error in the accessed storage area 31a is larger than a second predetermined value (Step S233). In Step S233, the control device 20 determines whether the count number of the first counter 24a in the accessed storage area 31a is larger than the second predetermined value.

The second predetermined value is, for example, an integer greater than or equal to 1. The second predetermined value may be 0. The second predetermined value may be equal to the first predetermined value or may be different from the first predetermined value. The count number of the first counter 24a in each storage area 31a may be reset when the storage area 31a is set as the read cache area or may not be reset. The second predetermined value is appropriately set according to whether the second counter 24b is reset. When the first counter 24a is not reset when the storage area 31a is set as the read cache area, the control device 20 adds the number of correctable errors occurring in the storage area 31a having been set as the read cache area to the count number of the first counter 24a when the storage area 31a is set as the read cache area. In this case, the control device 20 performs the determination of Step S233 through comparison between the sum of correctable errors since before the storage area 31a is set as the read cache area and the second predetermined value.

When it is determined in Step S233 that the count number of correctable errors is larger than the second predetermined value (Step S233: YES), the control device 20 determines that the second occurrence condition has been satisfied (Step S230: YES). In the first embodiment, when a storage area 31a is set as a read cache area due to the satisfaction of the first determination condition, the condition in which the count number of errors which can be corrected by the error correction function is larger than the second predetermined value is a predetermined third determination condition. That is, in the first embodiment, when the predetermined third determination condition has been satisfied, the control device 20 determines that the error occurrence situation satisfies the second occurrence condition. When it is determined in Step S233 that the count number of correctable errors is equal to or smaller than the second predetermined value (Step S233: NO), the control device 20 determines that the second occurrence condition has not been satisfied (Step S230: NO).

When it is determined in Step S232 that the error is an uncorrectable error (Step S232: NO), the control device 20 determines whether the count number of uncorrectable errors in the accessed storage area 31a is larger than a third predetermined value (Step S234). In Step S234, the control device 20 determines whether the count number of the second counter 24b in the accessed storage area 31a is larger than the third predetermined value.

The third predetermined value is, for example, an integer greater than or equal to 1. The third predetermined value may be 0. The third predetermined value may be, for example, smaller than the second predetermined value. The third predetermined value may be equal to the second predetermined value or larger than the second predetermined value. The third predetermined value may be equal to the first predetermined or different from the first predetermined value. The count number of the second counter 24b in each storage area 31a may be reset or may not be reset when the storage area 31a is set as a read cache area. The third predetermined value is appropriately set according to whether the second counter 24b is reset. The second counter 24b may not count an uncorrectable error before a storage area 31a is set as a read cache area. In this case, the second counter 24b starts counting an uncorrectable error after the storage area 31a has been set as a read cache area.

When it is determined in Step S234 that the count number of uncorrectable errors is larger than the third predetermined value (Step S234: YES), the control device 20 determines that the second occurrence condition has been satisfied (Step S230: YES). In the first embodiment, when a storage area 31a is set as a read cache area due to the satisfaction of the first determination condition, the condition in which the count number of errors which cannot be corrected by the error correction function is larger than the third predetermined value is a predetermined fourth determination condition. That is, when the predetermined fourth determination condition has been satisfied, the control device 20 according to the first embodiment determines that the error occurrence situation satisfies the second occurrence condition. When it is determined in Step S234 that the count number of uncorrectable errors is equal to or less than the third predetermined value (Step S234: NO), the control device 20 determines that the second occurrence condition has not been satisfied (Step S230: NO).

When it is determined in Step S231 that the storage area 31a is not set as a read cache area due to the satisfaction of the first determination condition, that is, when the storage area 31a is set as a read cache area due to the satisfaction of the second determination condition (Step S231: NO), the control device 20 determines whether the sum of the count numbers of errors is larger than a fourth predetermine value (Step S235). The sum of the count numbers of errors is a sum of the count number of an error which can be corrected by the error correction function and the count number of an error which cannot be corrected by the error correction function. In Step S235, the control device 20 determines whether the sum value of the count number of the first counter 24a and the count number of the second counter 24b in the accessed storage area 31a is larger than the fourth predetermined value.

The fourth predetermined value is, for example, an integer greater than or equal to 1. The fourth predetermined value may be 0. The fourth predetermined value may be equal to any of the first predetermined value, the second predetermined value, and the third predetermination or may be different from any of the first predetermined value, the second predetermined value, and the third predetermined value. The fourth predetermined value is appropriately set according to whether the first counter 24a and the second counter 24b are reset when the storage area 31a is set as a read cache area. Each of the first predetermined value, the second predetermined value, the third predetermined value, and the fourth predetermined value can be determined for each product on the basis of a specific test, specific verification, or the like. For example, when a result indicating that a probability of occurrence of a permanent defect in a storage area 31a is higher when a specific error has occurred a certain number of times than when the specific error has occurred less than the certain number of times is obtained through a specific test, specific verification, or the like, the predetermined values are determined on the basis of the certain number of times.

The control device 20 may include a third counter that counts the number of errors regardless of whether an error can be corrected by the error correction function. In this case, in Step S235, the control device 20 may determine whether the count number of the third counter is larger than the fourth predetermined value. Similarly to the first counter 24a and the second counter 24b, the count number of the third counter may be reset or may not be reset when the storage area 31a is set as a read cache area.

When it is determined in Step S235 that the count number of errors is larger than the fourth predetermined value (Step S235: YES), the control device 20 determines that the second occurrence condition has been satisfied (Step S230: YES). In the first embodiment, when a storage area 31a is set as a read cache area due to the satisfaction of the second determination condition, the condition in which the count number of errors is larger than the fourth predetermined value is a predetermined fifth determination condition. That is, in the first embodiment, when the predetermined fifth determination condition has been satisfied, the control device 20 determines that the error occurrence situation satisfies the second occurrence condition. When it is determined in Step S235 that the count number of errors is equal to or less than the fourth predetermined value (Step S235: NO), the control device 20 determines that the second occurrence condition has not been satisfied (Step S230: NO).

As described above, the second occurrence condition in the first embodiment is that one of the third determination condition, the fourth determination condition, and the fifth determination condition has been satisfied.

Regarding counting of the number of times an error has occurred in the storage area 31a set as the read cache area, the count number of the first counter 24a and the count number of the second counter 24b may be reset when an error has not occurred at the time of accessing data in the storage area 31a or may be reset whenever access to data in the storage area 31a is performed a predetermined number of times. In this case, when the storage area 31a is set as a read cache area, the count number of the first counter 24a and the count number of the second counter 24b are reset.

As illustrated in FIG. 6, when it is determined in Step S230 that the second occurrence condition has not been satisfied (Step S230: NO), the control device 20 ends the process of accessing the first volatile memory 31. When it is determined in Step S230 that the second occurrence condition has been satisfied (Step S230: YES), the control device 20 performs a replacement process of replacing the storage area 31a in which the second occurrence condition has been satisfied with another storage area 31a (Step S240). When the replacement process is performed, the storage area 31a in which the second occurrence condition has been satisfied is set as an unavailable storage area 31a. When a command for using the storage area 31a is issued, the other storage area 31a is used instead of the storage area 31a. That is, when an error has occurred in reading data stored in the storage area 31a which is a read cache area and the error occurrence situation satisfies a predetermined second occurrence condition, the control device 20 performs the replacement process of setting the storage area 31a in which an error has occurred as an unavailable storage area 31a and replacing the storage area 31a in which an error has occurred with another storage area 31a. When it is determined in Step S230 that the second occurrence condition has been satisfied, the control device 20 may set the storage area 31a in which the second occurrence condition has been satisfied as an unavailable storage area 31a without the replacement process. In this case, after setting the storage area 31a as an unavailable storage area 31a, the control device 20 does not perform a process of writing data to the storage area 31a and a process of reading data from the storage area 31a.

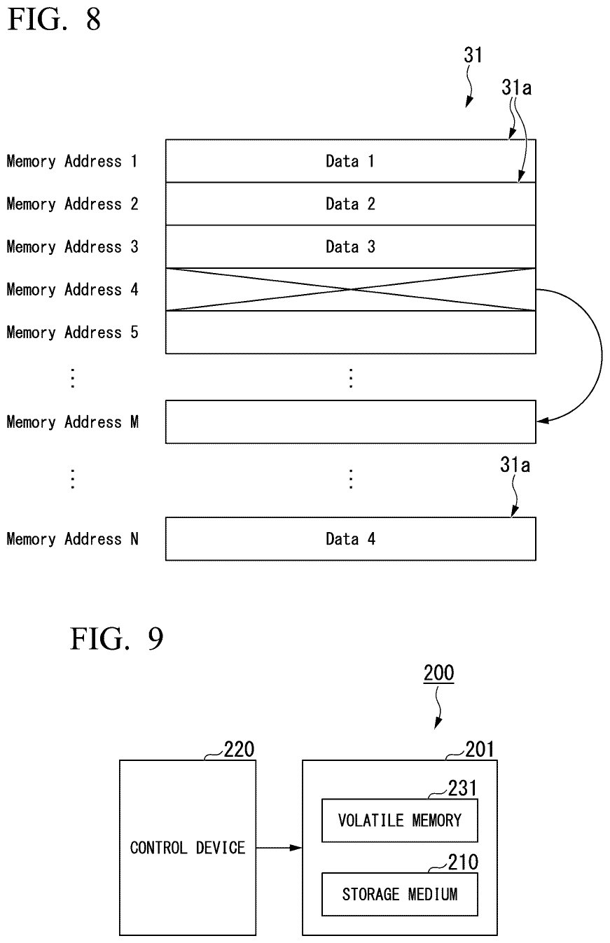

FIG. 8 is a diagram schematically illustrating storage areas in the first volatile memory 31 in which one storage area 31a which is a read cache area is set as an unavailable storage area 31a and subjected to the replacement process. In FIG. 8, an example in which a storage area 31a with memory address 4 set as a read cache area becomes an unavailable storage area 31a and the replacement process of replacing the storage area 31a with memory address 4 with a storage area 31a with memory address M has been performed is illustrated. Information indicating that a storage area 31a set as a read cache area is set as an unavailable storage area 31a and the replacement process has been performed is stored in the nonvolatile memory 33. The control device 20 stores a memory address of the storage area 31a set as an unavailable storage area 31a and a memory address of another storage area 31a used instead of the storage area 31a in the nonvolatile memory 33.

In the first embodiment, a determination pattern until a storage area 31a is set as an unavailable storage area 31a and the replacement process is performed includes three determination patterns such as a first determination pattern, a second determination pattern, and a third determination pattern. The first determination pattern is a pattern in which the first occurrence condition has been satisfied due to the satisfaction of the first determination condition, a storage area 31a is set as a read cache area, then the second occurrence condition has been satisfied due to the satisfaction of the third determination condition, the storage area 31a is set as an unavailable storage area 31a, and the replacement process is performed. The second determination pattern is a pattern in which the first occurrence condition has been satisfied due to the satisfaction of the first determination condition, a storage area 31a is set as a read cache area, then the second occurrence condition has been satisfied due to the satisfaction of the fourth determination condition, the storage area 31a is set as an unavailable storage area 31a, and the replacement process is performed. The third determination pattern is a pattern in which the first occurrence condition has been satisfied due to the satisfaction of the second determination condition, a storage area 31a is set as a read cache area, then the second occurrence condition has been satisfied because of satisfaction of the fifth determination condition, the storage area 31a is set as an unavailable storage area 31a, and the replacement process is performed.

In the third determination pattern, when a storage area 31a is set as a read cache area, an uncorrectable error occurs, and thus data in the storage area 31a cannot be correctly read. Accordingly, in the third determination pattern, when data stored in the storage area 31a is read data, the control device 20 accesses a place in which the read data is stored in the disk 10 serving as a source when the read data is written to the storage area 31a, reads the read data, and writes the read data to another storage area 31a other than the storage area 31a in which the error has occurred or writes the read data to the storage area 31a in which the error has occurred again. In third determination pattern, when data stored in a storage area 31a is fixed data, the control device 20 accesses a place in which the fixed data is stored in the disk 10 serving as a source when the fixed data is written to the storage area 31a, reads the fixed data, and writes the fixed data to another storage area 31a other than the storage area 31a in which the error has occurred. In the third determination pattern, when data stored in a storage area 31a is write data, for example, the control device 20 sends an error indicating that data cannot be read to the host device 40 and causes the host device 40 to issue a command for writing data again.

In the third determination pattern, when the stored data is read data, the control device 20 in Step S140 may write the read data to the storage area 31a in which an error has occurred, that is, the storage area 31a set as the read cache area or write the read data to another storage area 31a. In this case, the other storage area 31a to which the read data has been written can be overwritten. In the third determination pattern, when the stored data is write data, the control device 20 writes the write data to another storage area 31a in Step S140. In this case, the other storage area 31a to which the write data has been written can be overwritten. In the third determination pattern, when the stored data is fixed data, the control device 20 writes the fixed data to another storage area 31a in Step S140. In this case, the other storage area 31a to which the fixed data has been written cannot be overwritten.

Information indicating whether each of a plurality of storage areas 31a of the first volatile memory 31 is normal, a read cache area, or an unavailable storage area 31a to be subjected to a replacement process is stored in the nonvolatile memory 33. Accordingly, even when the storage system 100 is powered off and data in the first volatile memory 31 disappears, a storage area 31a which is a read cache area before the storage system 100 is powered off is a read cache area when the storage system 100 is powered on again. Even when the storage system 100 is powered off and data in the first volatile memory 31 disappears, a storage area 31a which is an unavailable storage area 31a and which has been subjected to the replacement process before the storage system 100 is powered off is an unavailable storage area 31a to be subjected to the replacement process when the storage system 100 is powered on again.

A control method for the first volatile memory 31 according to the first embodiment is a control method that is performed by the control device 20. At least one of the functions of the control device 20 are realized, for example, by causing the microprocessor 21 to execute a program, that is, software, stored in the disk 10 or the nonvolatile memory 33. The program is a program causing the control device 20 which is a computer to perform the control method according to the first embodiment. At least one of the functions of the control device 20 may be realized by hardware including a circuit such as a large scale integration (LSI) circuit, an application-specific integrated circuit (ASIC), a field-programmable gate array (FPGA), and a graphics processing unit (GPU) or may be cooperatively realized by software and hardware. The control device 20 may be constituted by a plurality of devices.

The medium in which the program causing the control device 20 which is a computer to perform the control method according to the first embodiment is not particularly limited and may be a storage medium other than the disk 10 or the nonvolatile memory 33. The storage medium may be a separate storage medium provided in the storage system 100 or may be a storage medium provided separately from the storage system 100. The storage medium is, for example, a flexible disk, a magneto-optical disc, a random access memory (RAM), a read only memory (ROM), a CD-ROM, a hard disk drive (HDD), a solid state drive (SSD), or a flash memory. The program causing the control device 20 which is a computer to perform the control method according to the first embodiment may be transmitted to the control device 20 via an electric communication line.

According to the first embodiment, the control device 20 is a control device that is configured to control the first volatile memory 31. The control device 20 is configured such that when an error has occurred in reading data stored in a storage area 31a of the first volatile memory 31 and an error occurrence situation in the storage area 31a in which the error has occurred satisfies a predetermined first occurrence condition, the control device 20 sets the storage area 31a in which the error has occurred as a read cache area which is used to store read data read from the disk 10 which is a predetermined storage medium. In other words, the control method of controlling the first volatile memory 31 includes setting a storage area 31a in which an error has occurred as a read cache area which is used to store read data read from the disk 10 when an error has occurred in reading data stored in a storage area 31a of the first volatile memory 31 and an error occurrence situation in the storage area 31a in which the error has occurred satisfies a predetermined first occurrence condition. Accordingly, even when an error occurs in reading data stored in a storage area 31a of the first volatile memory 31, the storage area 31a is not immediately set as an unavailable storage area 31a. The storage area 31a is used as a read cache area when the predetermined first occurrence condition is satisfied. Accordingly, it is possible to curb an increase in the number of unavailable storage areas 31a in the first volatile memory 31. Since the read cache area is an area which is used to store read data read from the disk 10 which is a storage medium, original data of the data stored in the read cache area is stored in the disk 10. Accordingly, when a storage area 31a in which an error has occurred is used as a read cache area and read data stored in the storage area 31a in which an uncorrectable error has occurred cannot be read, it is possible to correctly read the read data from the disk 10. As a result, even when the storage area 31a in which an error has occurred is not immediately set as an unavailable storage area 31a but set as a read cache area, it is possible to decrease an influence on the storage system 100 and to curb occurrence of a defect when the storage system 100 is used. When the storage medium in which the read data is stored is a storage medium other than the disk 10, the control device 20 can correctly read the read data from the other storage medium.

According to the first embodiment, the control device 20 is configured to determine that the error occurrence situation satisfies the first occurrence condition when the predetermined first determination condition has been satisfied. In other words, the control method according to the first embodiment includes determining that the error occurrence situation satisfies the first occurrence condition when the predetermined first determination condition has been satisfied. The first determination condition is a condition in which the count number of errors which can be corrected by the error correction function in the storage area 31a is larger than a first predetermined value. Accordingly, even when an error which can be corrected by the error correction function occurs, data read from the storage area 31a is corrected to correct data by the error correction function. Accordingly, when the occurred error is an error which can be corrected by the error correction function, the control device 20 can use the storage area 31a in which the error has occurred in the same way as when the error has not occurred. As a result, even if a correctable error occurs, reading of data from the storage area 31a is not hindered. On the other hand, when a correctable error occurs frequently, there is a likelihood that there is a certain defect in the storage area 31a. Accordingly, by appropriately setting the first predetermined value, it is possible to use the storage area 31a in the same way as a normal storage area 31a when a correctable error does not occur many and to use the storage area 31a with a high likelihood that a defect occurs as a read cache area when a correctable error occurs frequently.

According to the first embodiment, the control device 20 is configured to determine that the error occurrence situation satisfies the first occurrence condition when the predetermined second determination condition has been satisfied. In other words, the control method according to the first embodiment includes determining that the error occurrence situation satisfies the first occurrence condition when the predetermined second determination condition has been satisfied. The second determination condition is a condition in which the error occurred in the storage area 31a is an error which cannot be corrected by the error correction function. Here, when an error which cannot be corrected by the error correction function occurs, data cannot be correctly read from the storage area 31a in which the error has occurred. Accordingly, an uncorrectable error has great influence on the storage system 100 in comparison with a correctable error. When an uncorrectable error occurs, the error may be a hard error which occurs permanently and not a soft error which occurs temporarily. As a result, when an error which cannot be corrected by the error correction function occurs, it is possible to curb occurrence of a defect in the storage system 100 by immediately setting the storage area 31a in which the error has occurred as a read cache area.

According to the first embodiment, the control device 20 is configured to write the stored data stored in the storage area 31a in which the first occurrence condition has been satisfied to another storage area 31a of the first volatile memory 31 when the stored data is data other than read data read from the disk 10 which is a storage medium and is fixed data stored in the disk 10. In other words, the control method according to the first embodiment includes writing the stored data stored in the storage area 31a in which the first occurrence condition has been satisfied to another storage area 31a of the first volatile memory 31 when the stored data is data other than read data read from the disk 10 which is a storage medium and is fixed data stored in the disk 10. Accordingly, even when the storage area 31a is set as a read cache area, the control device 20 can read fixed data, which is same as the fixed data that was originally stored in the storage area 31a set as the read cache area, from the other storage area 31a. As a result, even when the storage area 31a in which an error has occurred is set as a read cache area, it is possible to further curb occurrence of a defect in the storage system 100.

According to the first embodiment, the control device 20 is configured such that when an error has occurred in reading data stored in the storage area 31a set as the read cache area and the error occurrence situation satisfies a predetermined second occurrence condition, the control device 20 sets the storage area 31a in which the error has occurred as an unavailable storage area 31a. In other words, the control method of controlling the first volatile memory 31 includes, when an error has occurred in reading data stored in the storage area 31a set as the read cache area and an error occurrence situation satisfies the predetermined second occurrence condition, setting the storage area 31a in which the error has occurred as an unavailable storage area 31a. In a storage area 31a in which an error occurs frequently even after it has been set as a read cache area, there is a high likelihood that a hard error which is permanent occurs. Accordingly, by appropriately setting the second occurrence condition and setting a storage area 31a in which an error occurs frequently as an unavailable storage area 31a, it is possible to curb occurrence of a defect in the storage system 100.

According to the first embodiment, the control device 20 is configured to determine that the error occurrence situation satisfies the second occurrence condition when a predetermined third determination condition has been satisfied. In other words, the control method according to the first embodiment includes determining that the error occurrence situation satisfies the second occurrence condition when the predetermined third determination condition has been satisfied. The third determination condition is a condition in which the count number of errors which can be corrected by the error correction function in the storage area 31a set as the read cache area is larger than a second predetermined value when the storage area 31a is set as the read cache area due to the satisfaction of the first determination condition. When even an error which can be corrected by the error correction function occurs frequently, there is a high likelihood that a permanent defect, that is, a permanent error (a hard error), occurs in the storage area 31a in which the error has occurred. Accordingly, by determining that the second occurrence condition has been satisfied when the count number of correctable errors in the storage area 31a in which the count number of correctable errors is larger than the first predetermined value and which is set as the read cache area is larger than the second predetermined value, the control device 20 can set the storage area 31a with a high likelihood that a permanent defect occurs as an unavailable storage area 31a. Accordingly, it is possible to further curb occurrence of a defect in the storage system 100.

According to the first embodiment, the control device 20 is configured to determine that the error occurrence situation satisfies the second occurrence condition when a predetermined fourth determination condition has been satisfied. In other words, the control method according to the first embodiment includes determining that the error occurrence situation satisfies the second occurrence condition when the predetermined fourth determination condition has been satisfied. The fourth determination condition is a condition in which the count number of errors which cannot be corrected by the error correction function in the storage area 31a set as the read cache area is larger than a third predetermined value when the storage area 31a is set as the read cache area due to the satisfaction of the first determination condition. When an uncorrectable error occurs frequently in the storage area 31a in which the count number of correctable errors is larger than the first predetermined value and which is set as the read cache area, there is a high likelihood that a permanent defect occurs in the storage area 31a. Accordingly, by determining that the second occurrence condition has been satisfied when the count number of uncorrectable errors in the storage area 31a in which the count number of correctable errors is larger than the first predetermined value and which is set as the read cache area is larger than the third predetermined value, the control device 20 can set the storage area 31a with a high likelihood that a permanent defect occurs as an unavailable storage area 31a. Accordingly, it is possible to further curb occurrence of a defect in the storage system 100.

An uncorrectable error more affects the storage system 100 in comparison with a correctable error. Accordingly, for example, by setting the third predetermined value to be less than the second predetermined value, it is possible to rapidly set a storage area 31a as an unavailable storage area 31a when an uncorrectable error occurs frequently in the storage area 31a set as a read cache area. Accordingly, it is possible to further curb occurrence of a defect in the storage system 100.

According to the first embodiment, the control device 20 is configured to determine that the error occurrence situation satisfies the second occurrence condition when a predetermined fifth determination condition has been satisfied. In other words, the control method according to the first embodiment includes determining that the error occurrence situation satisfies the second occurrence condition when the predetermined fifth determination condition has been satisfied. The fifth determination condition is a condition in which a sum of the count number of errors which can be corrected by the error correction function and the count number of errors which cannot be corrected by the error correction function in the storage area 31a set as the read cache area is larger than a fourth predetermined value when the storage area 31a is set as a read cache area due to the satisfaction of the second determination condition. In a storage area 31a which is set as a read cache area due to the occurrence of an uncorrectable error, there is a higher likelihood that a permanent defect occurs in comparison with a storage area 31a which is set as a read cache area due to the satisfaction of the first determination condition. Accordingly, by determining that the second occurrence condition has been satisfied when the count number of errors in a storage area 31a in which an uncorrectable error has occurred and which is set as a read cache area is larger than the fourth predetermined value regardless of whether the error is a correctable error or an uncorrectable error, the control device 20 can rapidly set the storage area 31a with a high likelihood that a permanent defect occurs as an unavailable storage area 31a. Accordingly, it is possible to further curb occurrence of a defect in the storage system 100.

According to the first embodiment, the control device 20 is configured to perform a replacement process of replacing the storage area 31a in which the error has occurred with another storage area 31a of the first volatile memory 31 when the storage area 31a is set as the read cache area and the error occurrence situation satisfies the second occurrence condition. In other words, the control method according to the first embodiment includes performing the replacement process of replacing the storage area 31a in which the error has occurred with another storage area 31a of the first volatile memory 31 when the storage area 31a is set as the read cache area and the error occurrence situation satisfies the second occurrence condition. Accordingly, it is possible to use another storage area 31a instead of the storage area 31a which is set as an unavailable storage area 31a.

According to the first embodiment, the storage system 100 is a disk device including a disk 10 as a storage medium. Accordingly, it is possible to curb an increase in the number of unavailable storage areas in the first volatile memory 31 regardless of the host device 40 to which the disk device as the storage system 100 is connected.

In the first embodiment, the nonvolatile memory 33 in addition to the disk 10 or instead of the disk 10 may correspond to a “storage medium.” In this case, read data read from the nonvolatile memory 33 is stored in the first volatile memory 31. In the first embodiment, the second volatile memory 32 may be controlled in the same way as the first volatile memory 31 by the control device 20.

### Second Embodiment

FIG. 9 is a block diagram illustrating a storage system 200 according to a second embodiment. The storage system 200 illustrated in FIG. 9 includes a control device 220 and a storage device 201. The control device 220 is, for example, a personal computer. The storage device 201 is, for example, a magnetic disk device in which a hard disk drive is built in. The storage device 201 may be an SSD. The storage device 201 is connected to the control device 220. The storage device 201 includes a volatile memory 231 and a storage medium 210. The volatile memory 231 is, for example, a DRAM. The volatile memory 231 may be an SRAM, an SDRAM, an FeRAM, an MRAM or the like. The volatile memory 231 is used as a cache of read data which is read from the storage medium 210 and write data which is written to the storage medium 210. When the storage device 201 is a magnetic disk device, the storage medium 210 is a magnetic disk. When the storage device 201 is an SSD, the storage medium 210 is a flash memory.

The control device 220 is configured to control the volatile memory 231. A control method for the volatile memory 231 that is performed by the control device 220 is the same as the control method for the first volatile memory 31 that is performed by the control device 20 according to the first embodiment. Similarly to the control device 20 according to the first embodiment, the control device 220 sets a storage area in the volatile memory 231 as a read cache area when a predetermined first occurrence condition has been satisfied. Accordingly, similarly to the first embodiment, it is possible to curb an increase in the number of unavailable storage areas in the volatile memory 231.

According to at least one of the aforementioned embodiments, the control device is a control device that is configured to control a volatile memory. The control device is configured such that when an error has occurred in reading data stored in a storage area of the volatile memory and an error occurrence situation in the storage area in which the error has occurred satisfies a predetermined first occurrence condition, the control device according to the embodiment sets the storage area in which the error has occurred as a read cache area which is used to store read data read from a predetermined storage medium. Accordingly, even when an error occurs, a storage area of the volatile memory is not immediately set as an unavailable storage area. As a result, it is possible to curb an increase in the number of unavailable storage areas in the volatile memory.

The first occurrence condition is not particularly limited. The first occurrence condition may be, for example, a condition in which an error has occurred once regardless of whether it is a correctable error or an uncorrectable error. The second occurrence condition is not particularly limited. The second occurrence condition may be, for example, a condition in which an error has occurred a predetermined number of times or more regardless of a determination condition when a storage area set as a read cache area. The storage medium may be any storage medium as long as data is stored therein. In the storage system, the control device, the storage medium, and the volatile memory may be provided in different devices.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device that is configured to control a volatile memory, wherein, the control device is configured such that when an error has occurred in reading data stored in a storage area of the volatile memory and an error occurrence situation in the storage area in which the error has occurred satisfies a predetermined first occurrence condition, the control device sets the storage area in which the error has occurred as a read cache area which is used to store read data read from a predetermined storage medium.

2. The control device according to claim 1, wherein the control device is configured to determine that the error occurrence situation satisfies the first occurrence condition when a predetermined first determination condition has been satisfied, and
wherein the first determination condition is a condition in which a count number of errors which can be corrected by an error correction function in the storage area is larger than a first predetermined value.

3. The control device according to claim 1, wherein the control device is configured to determine that the error occurrence situation satisfies the first occurrence condition when a predetermined second determination condition has been satisfied, and
wherein the second determination condition is a condition in which the error occurred in the storage area is an error which cannot be corrected by an error correction function.

4. The control device according to claim 1, wherein the control device is configured to write stored data stored in the storage area in which the first occurrence condition has been satisfied to another storage area of the volatile memory when the stored data is data other than read data read from the storage medium and is data stored in the storage medium.

5. The control device according to claim 1, wherein the control device is configured such that when an error has occurred in reading data stored in the storage area set as the read cache area and the error occurrence situation satisfies a predetermined second occurrence condition, the control device sets the storage area in which the error has occurred as an unavailable storage area.

6. The control device according to claim 2, wherein the control device is configured such that when an error has occurred in reading data stored in the storage area set as the read cache area and the error occurrence situation satisfies a predetermined second occurrence condition, the control device sets the storage area in which the error has occurred as an unavailable storage area,
wherein the control device is configured to determine that the error occurrence situation satisfies the second occurrence condition when a predetermined third determination condition has been satisfied, and
wherein the third determination condition is a condition in which a count number of errors which can be corrected by the error correction function in the storage area set as the read cache area is larger than a second predetermined value when the storage area is set as the read cache area due to the satisfaction of the first determination condition.

7. The control device according to claim 2, wherein the control device is configured such that when an error has occurred in reading data stored in the storage area set as the read cache area and the error occurrence situation satisfies a predetermined second occurrence condition, the control device sets the storage area in which the error has occurred as an unavailable storage area,
wherein the control device is configured to determine that the error occurrence situation satisfies the second occurrence condition when a predetermined fourth determination condition has been satisfied, and
wherein the fourth determination condition is a condition in which a count number of errors which cannot be corrected by the error correction function in the storage area set as the read cache area is larger than a third predetermined value when the storage area is set as the read cache area due to the satisfaction of the first determination condition.

8. The control device according to claim 3, wherein the control device is configured such that when an error has occurred in reading data stored in the storage area set as the read cache area and the error occurrence situation satisfies a predetermined second occurrence condition, the control device sets the storage area in which the error has occurred as an unavailable storage area,
wherein the control device is configured to determine that the error occurrence situation satisfies the second occurrence condition when a predetermined fifth determination condition has been satisfied, and
wherein the fifth determination condition is a condition in which a sum of a count number of errors which can be corrected by the error correction function and a count number of errors which cannot be corrected by the error correction function in the storage area set as the read cache area is larger than a fourth predetermined value when the storage area is set as the read cache area due to the satisfaction of the second determination condition.

9. The control device according to claim 5, wherein the control device is configured to perform a replacement process of replacing the storage area in which the error has occurred with another storage area of the volatile memory when the storage area is set as the read cache area and the error occurrence situation satisfies the second occurrence condition.

10. A storage system comprising:
a storage medium;
a volatile memory; and
a control device that is configured to control a volatile memory,
wherein, the control device is configured such that when an error has occurred in reading data stored in a storage area of the volatile memory and an error occurrence situation in the storage area in which the error has occurred satisfies a predetermined first occurrence condition, the control device sets the storage area in which the error has occurred as a read cache area which is used to store read data read from the storage medium.

11. The storage system according to claim 10, wherein the storage system is a disk device including a disk as the storage medium.

12. A control method of controlling a volatile memory, the control method comprising, when an error has occurred in reading data stored in a storage area of the volatile memory and an error occurrence situation in the storage area in which the error has occurred satisfies a predetermined first occurrence condition, setting the storage area in which the error has occurred as a read cache area which is used to store read data read from a predetermined storage medium.

13. The control method according to claim 12, further comprising determining that the error occurrence situation satisfies the first occurrence condition when a predetermined first determination condition has been satisfied,
wherein the first determination condition is a condition in which a count number of errors which can be corrected by an error correction function in the storage area is larger than a first predetermined value.

14. The control method according to claim 12, further comprising determining that the error occurrence situation satisfies the first occurrence condition when a predetermined second determination condition has been satisfied,
wherein the second determination condition is a condition in which the error occurred in the storage area is an error which cannot be corrected by an error correction function.

15. The control method according to claim 12, further comprising, when an error has occurred in reading data stored in the storage area set as the read cache area and the error occurrence situation satisfies a predetermined second occurrence condition, setting the storage area in which the error has occurred as an unavailable storage area.

16. The control method according to claim 13, further comprising:
when an error has occurred in reading data stored in the storage area set as the read cache area and the error occurrence situation satisfies a predetermined second occurrence condition, setting the storage area in which the error has occurred as an unavailable storage area; and
determining that the error occurrence situation satisfies the second occurrence condition when a predetermined third determination condition has been satisfied,
wherein the third determination condition is a condition in which a count number of errors which can be corrected by the error correction function in the storage area set as the read cache area is larger than a second predetermined value when the storage area is set as the read cache area due to the satisfaction of the first determination condition.

17. The control method according to claim 13, further comprising:
when an error has occurred in reading data stored in the storage area set as the read cache area and the error occurrence situation satisfies a predetermined second occurrence condition, setting the storage area in which the error has occurred as an unavailable storage area; and
determining that the error occurrence situation satisfies the second occurrence condition when a predetermined fourth determination condition has been satisfied,
wherein the fourth determination condition is a condition in which a count number of errors which cannot be corrected by the error correction function in the storage area set as the read cache area is larger than a third predetermined value when the storage area is set as the read cache area due to the satisfaction the first determination condition.

18. The control method according to claim 14, further comprising:
when an error has occurred in reading data stored in the storage area set as the read cache area and the error occurrence situation satisfies a predetermined second occurrence condition, setting the storage area in which the error has occurred as an unavailable storage area; and
determining that the error occurrence situation satisfies the second occurrence condition when a predetermined fifth determination condition has been satisfied,
wherein the fifth determination condition is a condition in which a sum of a count number of errors which can be corrected by the error correction function and a count number of errors which cannot be corrected by the error correction function in the storage area set as the read cache area is larger than a fourth predetermined value when the storage area is set as the read cache area due to the satisfaction of the second determination condition.

19. The control method according to claim 15, further comprising performing a replacement process of replacing the storage area in which the error has occurred with another storage area of the volatile memory when the storage area is set as the read cache area and the error occurrence situation satisfies the second occurrence condition.

20. A program causing a computer to perform a control method of controlling a volatile memory, the control method comprising, when an error has occurred in reading data stored in a storage area of the volatile memory and an error occurrence situation in the storage area in which the error has occurred satisfies a predetermined first occurrence condition, setting the storage area in which the error has occurred as a read cache area which is used to store read data read from a predetermined storage medium.
